(19) United States
(12) Patent Application Publication
(10) Pub. No.: US 2026/0064354 A1
(43) Pub. Date: Mar. 5, 2026

(54) Multi-Radio Audio Hub

(71) Applicant: Shure Acquisition Holdings, Inc., Niles, IL (US)

(72) Inventors: William Wallace Taylor, III, Gurnee (IL); Joshua Sven Heise, Harwood Heights, IL (US); Joseph Michael Bradel, South Beloit, IL (US)

(21) Appl. No.: 19/288,353

(22) Filed: Aug. 1, 2025

Related U.S. Application Data
(60) Provisional application No. 63/687,504, filed on Aug. 27, 2024.

(51) Int. Cl. G06F 3/16; G10K 11/178; H04R 29/00

(52) U.S. Cl. CPC G06F 3/162; G10K 11/17823; G10K 11/17873; H04R 29/001; G10K 2210/3011; G10K 2210/3027

(57) ABSTRACT

Aspects of the disclosure relate to an audio hub that may be connected to a computing device. The audio hub may comprise multiple wired and wireless communication interfaces that may be used to interface multiple peripheral audio devices with the computing device. The audio hub may comprise a built-in reference microphone that may be used for noise cancelation, automatic gain control, and/or acoustic echo cancelation. The audio hub may additionally be configured for audio dosimetry measurements based on output audio signals as sent to an audio output device connected to the audio hub.

### CROSS-REFERENCE TO RELATED APPLICATION

This application claims the benefit of U.S. Provisional Patent Application No. 63/687,504, filed on August 27, 2024, which is fully incorporated herein by reference.

### TECHNICAL FIELD

Aspects of the disclosure relate to electronic audio communications and more specifically to an audio hub for interfacing peripheral audio devices to a computing device.

### BACKGROUND

Peripheral audio devices may be connected to a computing device (e.g., a desktop computer, a laptop computer, a smartphone, a tablet, etc.) for enhanced operation and/or user experience. Peripheral audio devices may include microphones, speakers, headphones, and/or other devices capable of generating an audio output and/or receiving an audio input.

### SUMMARY

Aspects of the disclosure provide effective, scalable, and reliable technical solutions that address and overcome the problems associated with interfacing, using one or more wired and/or wireless communication protocols, multiple audio devices with a computing device (e.g., a laptop computer, a desktop computer, a smartphone, a tablet, etc.). More specifically, a wireless hub may be used to interface one or more peripheral audio devices to a computing device. Additionally, the wireless hub may have built-in capabilities for noise reduction, audio dosimetry, automatic gain control, echo cancelation, etc.

An example audio hub may comprise a reference microphone (e.g., an integrated/internal reference microphone) and a plurality of communication interfaces for communication with one or more audio devices. The plurality of communication interfaces may use one or more communication protocols (e.g., wired communication protocols and/or wireless communication protocols). The audio hub may additionally be connected to a computing device (e.g., via a wired communication interface). The audio hub may perform noise reduction using the reference microphone. For example, the audio hub may receive, from the reference microphone, a noise audio signal and generate, based on the noise audio signal, a noise canceling signal. Further, the audio hub may receive, from a primary microphone (e.g., connected to the audio hub via a first communication interface of the plurality of communication interfaces), an input audio signal. The audio hub may generate an output audio signal based on the input audio signal and the noise canceling signal. The audio hub may send, via the wired communication interface and to the computing device, the output audio signal.

The audio hub may use the reference microphone for one or more other operations. For example, the audio hub may use the reference microphone for performing automatic gain control (AGC) or acoustic echo cancelation (AEC). The reference microphone may be operated as a primary microphone if no other microphone is connected to the audio hub. The audio hub may track an audio level being provided to an output device (e.g., a speaker, headphones, etc.) for audio dosimetry measurements. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B show an example audio hub;

FIG. 1C shows an example audio system;

FIG. 1D shows an example operation of an audio hub;

FIG. 1E shows an example configuration of a system comprising an audio hub and multiple audio devices;

FIG. 2 shows an example method for operating an audio hub to receive audio input;

FIG. 3 shows an example method for using a reference microphone for noise reduction;

FIG. 4 shows an example method for detecting compatible audio devices for performing real-time audio dosimetry;

FIG. 5 shows an example method for real-time audio dosimetry as performed by the audio hub; and

FIG. 6 shows an example method for selecting an audio codec.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

Computing devices (e.g., desktop computers, laptop computers, smartphones, tablets, etc.) may be equipped with various wired and/or wireless interfaces to enable operation of one or more peripheral devices. Peripheral devices may include various audio input/output devices that the user may prefer to use (e.g., over built-in audio devices). For example, a wireless microphone may be connected to a computing device (e.g., via a Bluetooth interface) to enable wireless audio input for an audio/video call. Similarly, an external speaker or headphones may be connected to the computing device (e.g., via a 3.5 mm audio connector) to enable higher quality audio output for the call.

The wired/wireless interfaces associated with a computing device may have limited functionality and/or may not have sufficient flexibility. For example, a computing device may be equipped with a standard Bluetooth interface that may be used to connect wireless headphones. However, the Bluetooth standard may have latency and/or throughput issues that may limit the functionality of a peripheral device.

In some scenarios, the user may wish to connect more than one audio input/output device to the computing device. The computing device may have limitations with respect to a quantity of devices that may be connected. The computing device may only enable connection with a single wireless device. For example, the Bluetooth interface provided in the computing device may only be used to connect a single device (e.g., a single set of headphones). Similarly, the computing device may only have a limited quantity of output ports that may be used to connect peripheral devices. After connecting to standard peripheral devices (e.g., such as a keyboard, a mouse, a printer, one or more monitors, etc.), there may only be a limited set of interfaces/ports that the user may use for connecting audio devices.

Various examples herein describe an audio hub that may be used to flexibly connect one or more audio devices to a computing device. Audio devices may comprise wired and/or wireless speakers, headphones, microphones, audio signal transceivers, and/or any other type of audio input and/or output device. The audio hub may comprise one or more radio interfaces corresponding to any proprietary and/or non-proprietary wireless communication protocol. For example, the one or more radio interfaces may conform to Bluetooth protocol(s), Institution of Electrical and Electronics Engineers (IEEE) 802.11 Wi-Fi protocol(s), a 3^{rd} Generation Partnership Project (3GPP) communication protocol (e.g., a 5G communication protocol, or any other 3GPP protocol), and/or any other wireless communication protocol. The audio hub may additionally comprise one or more wired interfaces to for connected wired audio devices. The one or more wired interfaces may comprise one or more XLR interface(s), universal serial bus (USB) interface(s), 3.5 mm audio interface(s), and/or any other proprietary and/or non-proprietary wired interface(s). Further, the audio hub may be connected to the computing device via a single interface (e.g., wired or wireless interface). For example, the audio hub may be connected to the computing device via a standard USB interface.

The multiple wired and/or wireless interfaces on the audio hub may enable a user to connect multiple audio devices, irrespective of interfaces/protocol types used by the audio devices, to a computing device. The audio hub may itself be connected to the computing device via a single interface, thereby considerably simplifying the setup and operation of multiple audio devices with the computing device.

The audio hub may comprise one or more reference microphones. The reference microphone(s) may be used for reduction of noise from audio input as received from one or more microphones (e.g., connected to the audio hub). The strategic placement of the reference microphone on the audio hub may enable reduction of noises associated with a workspace comprising the computing device (e.g., a table on which the computing device and audio hub may be located). Further, the output from the reference microphone may be used for reduction of noise from any microphone that may be connected to the audio hub.

The audio hub may flexibly configure the reference microphone as a primary microphone in some scenarios. For example, the audio hub may configure the reference microphone as a primary audio input microphone if no other microphone is connected to the audio hub.

The audio hub may also be configured for real-time audio dosimetry. For example, the audio hub may determine an output audio level (e.g., as provided by speaker, headphone, and/or any other audio output device connected to the audio hub). The audio hub may determine an output audio level based on an amplitude of an output audio signal as transmitted to the audio output device. The audio exposure may be determined based on the output audio level and a time period associated with the determined output audio level. The audio hub may provide a notification (e.g., via the computing device) indicating an audio exposure for a user. Additionally, or alternatively, the computing device may adjust an output audio level based on a determination of the audio exposure.

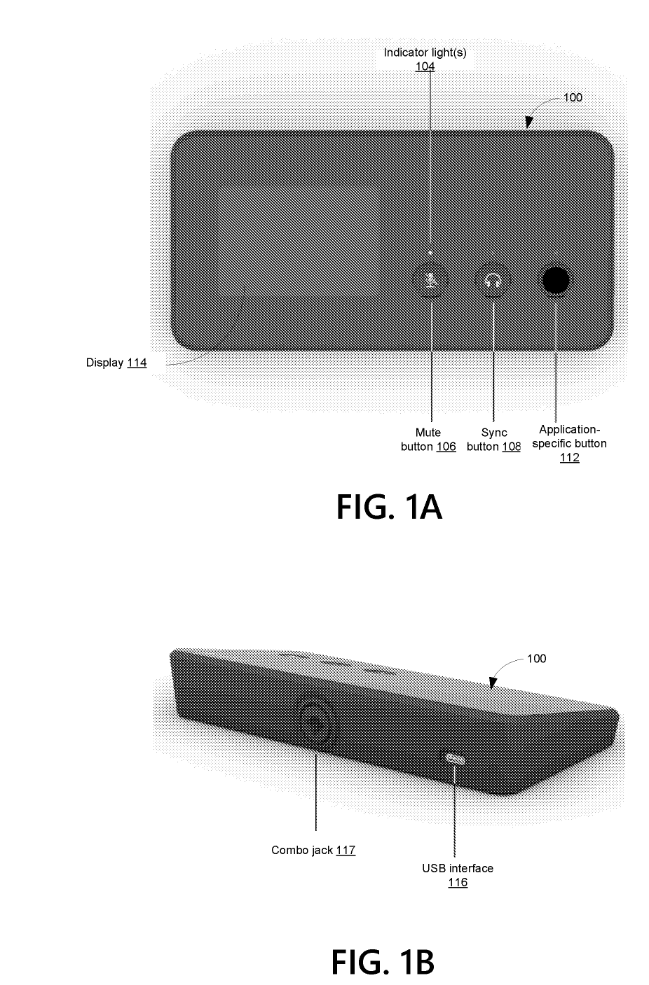

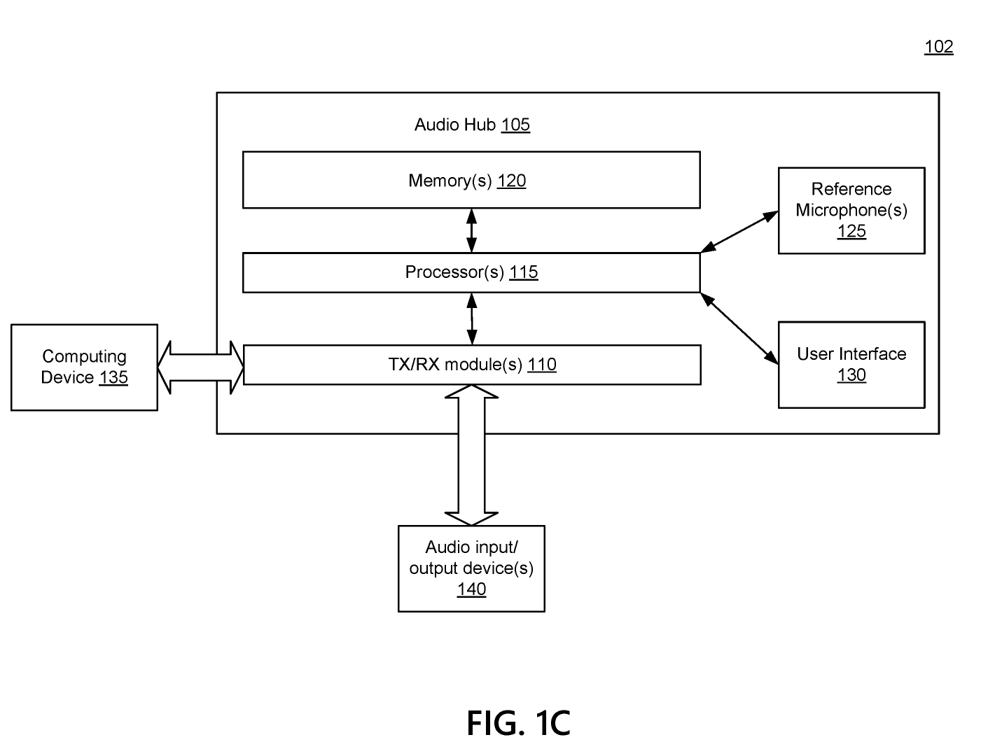

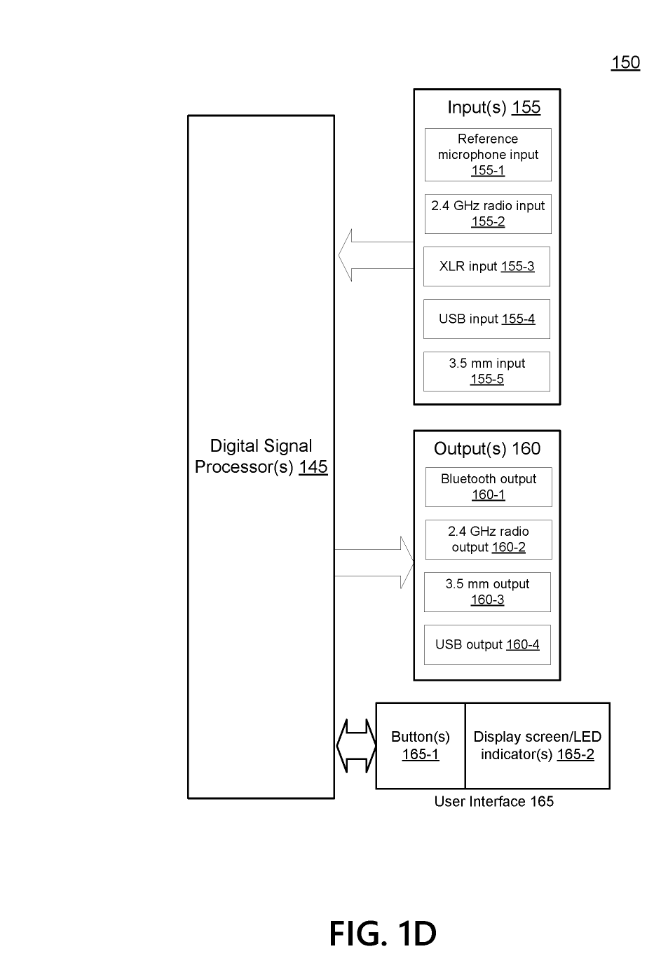

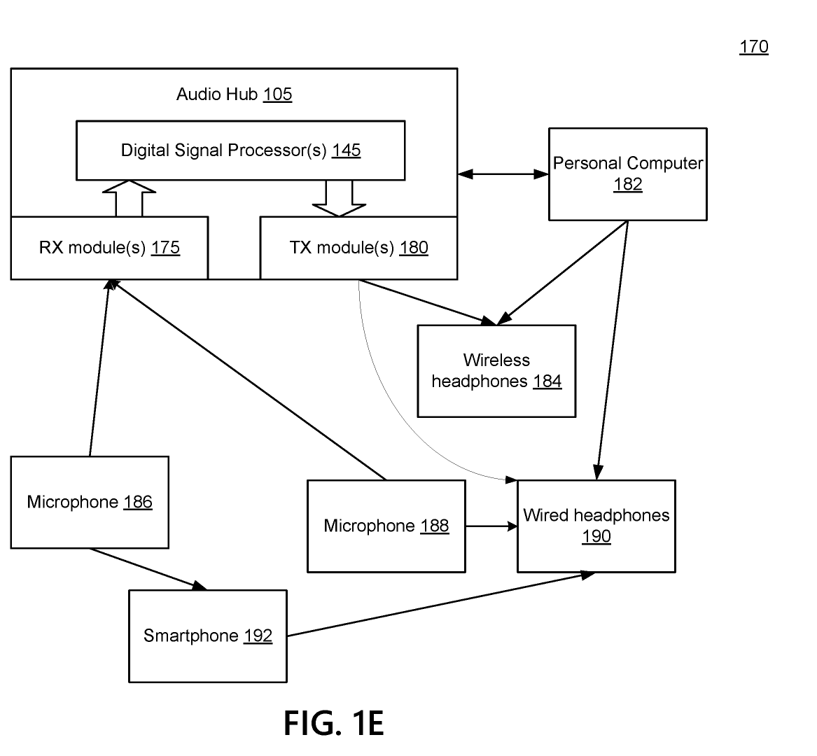

FIGS. 1A and 1B show an example audio hub 100. The example audio hub 100 may be used to connect one or more audio devices to a computing device. For example, the audio hub 100 may comprise a USB interface 116 and a combo jack 117 (e.g., capable of accepting both XLR input and ¼ inch audio input). In an example arrangement, the combo jack 117 may be used to connect an audio device to the audio hub 100, and the USB interface 116 may be used to connect the audio hub to a computing device. The audio hub 100 may additionally comprise one or more radio interfaces (not shown) to enable wireless communication with one or more audio devices and/or the computing device.

The audio hub 100 may further comprise a display 114 that may be used for one or more functionalities described herein. For example, the display 114 may be used to indicate a status of the audio hub (e.g., indications of one or more audio devices connected to the audio hub 100, indication of whether the audio hub 100 is successfully connected to a computing device, indication of any error codes, etc.).

The audio hub 100 may additionally comprise one or more physical buttons for controlling various operations. For example, the audio hub 100 may comprise a microphone mute button 106 (e.g., to mute a connected microphone and/or a built-in microphone), a sync button 108 (e.g., to wirelessly search and connect/pair one or more wireless audio devices with the audio hub 100), an application-specific button 112 (e.g., to implement one or more functionalities of an application operating on a connected computing device). For example, the application-specific button 112 may correspond to a video conferencing application (e.g., installed on the computing device) and may be used to receive and/or disconnect a video call via the computing device.

The audio hub 100 may additionally comprise one or more indicator lights 104 (e.g., light emitting diode (LED) lights) to indicate a status of the audio hub. For example, an indicator light above the mute button 106 may indicate whether a connected microphone is muted. An indicator light above the sync button 108 may indicate whether an audio device has been synced (e.g., wirelessly connected to the audio hub 100).

FIG. 1C shows an example audio system 102 in accordance with one or more examples as described herein. The audio system 102 may comprise an audio hub 105 that may be connected to one or more other devices (e.g., audio device(s) and/or a computing device). For example, the audio hub 105 may be connected to a computing device 135, one or more audio input/output devices 140. The audio hub 105 may comprise one or more of processor(s) 115, transmit (TX)/receive (RX) module(s) 110, and/or memory 120. The audio hub 105 may additionally comprise one or more reference microphone(s) 125 and a user interface 130.

One or more data buses may interconnect the processor(s) 115, the TX/RX module(s) 110, and/or the memory 120. The audio hub 105 may be implemented using one or more integrated circuits (ICs), software, or a combination thereof, configured to operate as described herein. The memory 120 may comprise any memory such as a random-access memory (RAM), a read-only memory (ROM), a flash memory, or any other electronically readable memory, or the like. The processor(s) 115, the TX/RX module(s) 110, and/or other component/modules of the audio hub 105 may be configured to execute machine readable instructions stored in the memory 120 to perform the various operations described herein.

The processor(s) 115 may implement functionalities associated with one or more layers of an open systems interconnection (OSI) model representing the operations of the audio hub 105. For example, the processor(s) 115 may perform various operations in accordance with one or more protocols for transmission, reception, and/or processing of signals. The processor(s) 115 may process received signals (e.g., as received from the audio input device(s), the computing device 135, and/or the reference microphone 125) for further transmission to one or more other devices (e.g., one or more audio output device(s) and/or the computing device 135).

The TX/RX module(s) 110 may comprise one or more of mixers, amplifiers, drivers, etc., for transmission, reception, and/or processing of signals. For example, the TX/RX module(s) 110 may receive audio signals from one or more audio input device(s) and send them for further processing by the processor(s) 115. Processed audio signals from the processor(s) 115 may be sent, via the TX/RX module(s) 110, to the computing device 135 for playback (e.g., via a speaker or any other audio output device connected to the computing device 135), storage in a memory of the computing device 135, or further transmission via a communication network (e.g., Internet). The TX/RX module(s) 110 may receive audio signals from the processor(s) 115 and send the audio signals for output via one or more audio output device(s). Communication of signals via the TX/RX module(s) 110 may be via a wireless communication interface (e.g., in accordance with one or more wireless communication protocols). For example, the TX/RX module(s) 110 may be interfaced with one or more antennas/antenna arrays to facilitate wireless communication. Additionally, or alternatively, the TX/RX module(s) 110 may comprise/be associated with wired interfaces/ports (e.g., one or more of XLR connector(s), USB connector(s), 3.5 mm connector(s), ethernet connector(s), etc.) to facilitate wired communication (e.g., in accordance with one or more wired communication protocols).

The audio hub 105 may communicate via any proprietary and/or non-proprietary wired/wireless communication standards. For example, the TX/RX module(s) 110 may be configured to send/receive signals (e.g., to/from the computing device 135 and/or audio input/output device(s) 140) that are processed using one or more communication protocols corresponding to one or more layers in the OSI model (e.g., Bluetooth protocol(s), IEEE 802.11 Wi-Fi protocol(s), 3GPP cellular protocol(s) (such as 4G, 5G, 6G, etc., protocols), local area network (LAN) protocol(s), hypertext transfer protocols (HTTP), side-channel communication protocol(s), and/or any other proprietary and/or non-proprietary communication protocol(s)).

In accordance with this multi-protocol functionality of the TX/RX module(s) 110, the processor(s) 115 may be configured with audio encoding/decoding functionalities in accordance with one or more audio protocols. For example, the processor(s) 115 may be configured to process (e.g., encode) audio signals for transmission (e.g., to audio output device(s) or the computing device 135) using one or more audio encoding protocols/audio codecs. Similarly, the processor(s) 115 may be configured to process (e.g., decode) audio signals (e.g., received from audio input device(s) and/or reference microphone(s) 125) in accordance with one or more audio decoding protocols/audio codecs.

In an example, the communications involving the system 102 may be via wireless channels that are designated as industrial, scientific, and medical (ISM) bands defined by the International Telecommunication Union (ITU) Radio Regulations (e.g., a 2.4 GHz-2.5 GHz band, a 5.75 GHz-5.875 GHz band, a 24 GHz-24.25 GHz band, and/or a 61 GHz-61.5 GHz band, etc.). Additionally, or alternatively, the communication between the devices in the communication system 102 may be via (e.g., one or more channels within) a very high frequency (VHF) band (e.g., 30 MHz-300 MHz band) and/or via (e.g., one or more channels within) an ultra-high frequency (UHF) band (e.g., 300 MHz-3 GHz).

The one or more reference microphone(s) 125 may comprise one or more of microelectromechanical systems (MEMS) microphone(s), condenser microphone(s), electret microphone(s) or any other types of microphone(s). The reference microphone(s) 125 may comprise any microphone with a wide and flat frequency response. The reference microphone(s) 125 may be integrated into the audio hub 105 and may be used for improving an audio quality of input audio as received from one or more other microphones (e.g., via the TX/RX module(s) 110). For example, audio received via the reference microphone(s) 125 may be used for noise reduction, echo cancelation, automatic gain control (AGC), and/or other algorithms to improve quality of audio received via other microphones. In at least some scenarios, the reference microphone 125 may be used as a primary microphone for receiving audio input.

The user interface 130 may be used to control one or more operations of the audio hub 105. The user interface 130 may comprise one or more buttons to operate one or more functions of the audio hub 105. For example, the user interface 130 may comprise a mute button to mute an audio input (e.g., via an external microphone) to the audio hub 105. The user interface 130 may comprise a mute button to mute an audio output (e.g., to a speaker connected to the audio hub 105). The user interface 130 may comprise a sync button to enable wireless connection (e.g., pairing) of an audio device to the audio hub 105. The user interface 130 may comprise one or more buttons to implement special functionalities with respect to the computing device 135 or audio input/output device(s) 140. For example, the audio hub 105 may comprise a button that may cause activation of an application (e.g., an audio/video conferencing application) at the computing device 135 and/or may cause receiving/disconnecting a call (e.g., via the audio/video conferencing application). The audio hub 105 may further comprise one or more indicators (e.g., light emitting diodes (LED) indicators) showing an operating status of the audio hub 105 (e.g., whether the audio hub 105 is powered on, whether an input microphone is muted, whether the audio hub 105 is connected to the computing device 135, etc.). In at least some examples, the audio hub 105 may comprise a display device or a touch screen display interface for implementing one or more of the above functionalities.

Audio input/output device(s) 140 may comprise audio input devices such as microphones, transceivers (e.g., associated with a musical or any audio instrument/device), and/or any other devices capable of transmitting audio packets/information. Audio input/output device(s) 140 may comprise audio output devices such as headphones, speakers, and/or any other devices capable of receiving audio packets/information.

The computing device 135 may comprise a desktop computer, a laptop computer, a smartphone, a tablet, or any other computing device. The computing device 135 may be connected to the audio hub 105 via a wired communication interface (e.g., USB interface, or any other wired interface). Additionally, or alternatively, the computing device 135 may be connected to the audio hub 105 via a wireless communication interface (e.g., using a Bluetooth communication protocol, a Zigbee communication protocol, a Wi-Fi communication protocol, and/or any other proprietary/non-proprietary wireless communication protocol).

In at least some arrangements, operations of the audio hub 105 may be controlled via the computing device 135. For example, an application operating on the computing device 135 may be used to route audio from one or more audio input devices, connected to the audio hub, to the computing device 135 or one or more audio output devices. Similarly, the application may be used to route audio from the computing device 135 to one or more audio output devices connected to the audio hub 105.

FIG. 1D shows an example operation 150 of an audio hub. The audio hub (e.g., the audio hub 105) may comprise one or more digital signal processor(s) (DSPs) 145 that may be used to process audio signals as received via one or more input(s) 155 and/or transmit audio signals via one or more output(s) 160. The input(s) 155 and output(s) 160 as shown in FIG. 1D are merely exemplary, and in other scenarios the audio hub may comprise different quantities and/or types of input(s)/output(s) (e.g., depending on a hardware configuration of the audio hub).

For example, the input(s) 155 may comprise one or more of a reference microphone input 155-1, a (proprietary or non-proprietary) 2.4 GHz radio input 155-2, an XLR input 155-3, a USB input 155-4, and/or a 3.5 mm input 155-5. The output(s) 160 may comprise one or more of a Bluetooth radio output 160-1, a (proprietary or non-proprietary) 2.4 GHz radio output 160-2, a 3.5 mm output 160-3, and/or a USB output 160-4.

The audio hub may additionally comprise a user interface 165 to control one or more functionalities of the audio hub. For example, the audio hub may comprise one or more buttons 165-1 (e.g., a power button, a mute button, a sync button, etc.). The audio hub may comprise a display screen and/or LED indicator(s) 165-2 to show an operating status of the audio hub (e.g., as described with reference to FIG. 1A). In an example, the display screen may be a touch-sensitive display screen that may be used to control various operations of the audio hub. In one such example, the physical buttons 165-1 may not be included in the audio hub and user input may be provided via the touch-sensitive display screen.

FIG. 1E shows an example configuration of a system 170 comprising an audio hub and multiple audio devices. The example system 170 may comprise the audio hub 105, a personal computer 182, and one or more audio devices connected to the audio hub 105 and/or the personal computer 182. The personal computer 182 may be connected to the audio hub 105 via a wired interface (e.g., a USB interface) or a wireless interface. The audio hub 105, if connected via a wired USB interface to the personal computer 182, may be powered via the USB interface.

The one or more audio devices may be connected to the audio hub via the RX module(s) 175 and/or the TX module(s) 180. The RX module(s) 175 and/or the TX module(s) 180 may comprise one or more wired and/or wireless interfaces that may be used for connecting the one or more audio devices to the audio hub 105. The audio hub 105 may additionally comprise the digital signal processor(s) 145 for processing audio for transmission (e.g., via the TX module(s) 180) and/or for processing received audio (e.g., via the RX module(s) 175).

The audio hub 105 may comprise one or more RX module(s) 175 that may be used to connect one or more audio input devices (e.g., microphones 186 and 188) to the audio hub 105. The audio input devices may be also flexibly connected to one or more other devices (e.g., in addition to the audio hub 105). For example, the microphone 186 may be connected to/paired with a smartphone 192 and the microphone 188 may be connected to/paired with wired headphones 190 (e.g., which may, in turn, be connected to the personal computer 182). In one example, connection of the microphones 186, 188 to the audio hub 105 may cause disconnection of the microphones 186, 188 to any other devices with which the microphones 186, 188 may have been previously paired.

The audio hub 105 may comprise one or more TX module(s) 180 that may be used to connect one or more audio output devices (e.g., wireless headphones 184, wired headphones 190) to the audio hub 105. The audio output devices may be also flexibly connected to one or more other devices (e.g., in addition to the audio hub 105). For example, the wireless headphones 184 may be connected to/paired with the personal computer 182. In one example, connection of the wireless headphones 184 to the audio hub 105 may cause disconnection of the wireless headphones 184 to any other devices with which the wireless headphones 184 may have been previously paired.

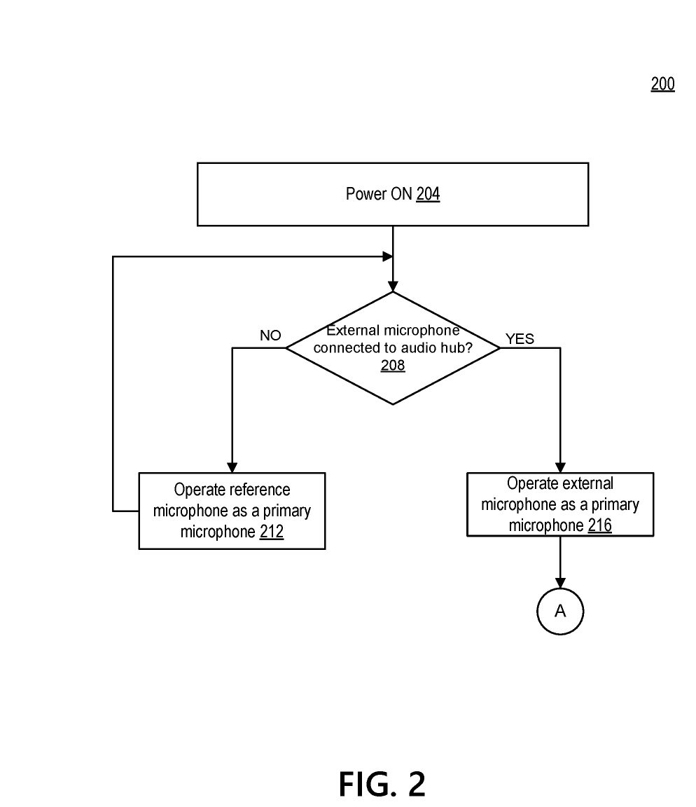

FIG. 2 shows an example method 200 for operating an audio hub to receive audio input. At step 204, the audio hub may be powered on. For example, the audio hub may be powered on by connecting the audio hub to an external power source, or by activating a built-in battery power supply integrated with the audio hub. Powering on the audio hub may further comprise connecting the audio hub to a computing device (e.g., the computing device 135 as shown in FIG. 1C).

At step 208, the audio hub may determine whether an external microphone has been connected to the audio hub. The external microphone may be connected to the audio hub using a wired interface or using a wireless interface. For example, the external microphone may be connected to the audio hub via an XLR connector, a 3.5 mm connector, a USB connector, and/or any other wired connector. Alternatively, the external microphone may be connected to the audio hub using a Bluetooth communication protocol, a Zigbee communication protocol, a Wi-Fi communication protocol, and/or any other wireless communication protocol.

The audio hub may determine that an external microphone has been connected to the audio hub based on receiving a handshake signal from the external microphone. For example, the external microphone may send a handshake signal, to the connected audio hub, identifying itself as a microphone. The handshake signal may indicate, for example, an identifier or model indicator of the microphone. The audio hub may determine that an external microphone has been connected to the audio hub based on detecting a load resistance at a wired connector (e.g., a load resistance across contacts associated with the wired connector) used to connect the external microphone to the audio hub.

At step 212, and if the audio hub determines that no external microphone has been connected to the audio hub, the audio hub may operate an integrated reference microphone of the audio hub (e.g., the reference microphone 125 as shown in FIG. 1) as a primary microphone. For example, the audio hub may use the reference microphone as a primary input device for receiving audio. The audio hub may generate an output audio signal based on audio signals as received via the reference microphone. The audio hub may send the output audio signals to a connected computing device (e.g., the computing device 135 as shown in FIG. 1). In an example arrangement, the audio hub may operate in a passthrough mode wherein the audio hub may forward audio signals, as received via the reference microphone, to the computing device without further processing.

At step 216, and if the audio hub determines that an external microphone has been connected to the audio hub, the audio hub may operate the external microphone as a primary microphone. For example, the audio hub may use the external microphone as a primary input device for receiving audio. The audio hub may generate an output audio signal based on audio signals as received via the external microphone. The audio hub may send the output audio signals to a connected computing device (e.g., the computing device 135 as shown in FIG. 1). In an example arrangement, the audio hub may operate in a passthrough mode wherein the audio hub may forward audio signals, as received via the external microphone, to the computing device without further processing.

If an external microphone is connected to the audio hub, the audio hub may use the reference microphone for processing audio as received via the external microphone. For example, the audio hub may use the reference microphone to perform functions such as automatic gain control (AGC), acoustic echo cancelation (AEC), and/or strategic noise reduction. In other examples, the reference microphone may be deactivated based on detecting that the external microphone has been connected to the audio hub.

The audio hub may use the reference microphone for AEC, for example, if an external speaker is also connected to the audio hub. The audio hub may compare an output signal being provided to the speaker with an audio signal as received from the reference microphone. Based on the comparison, the audio hub may generate/refine a model representing a transformation of an output audio, from the speaker, as it echoes across the environment and is received at the reference microphone. The audio hub may remove any effect of the output audio, from the speaker, on the external microphone based on the generated model.

The audio hub may use the reference microphone in conjunction with the external microphone to determine a position of a user. For example, the audio hub may process audio inputs received via the external microphone and the reference microphone to determine a user position. The audio hub may adjust, based on the user position, an AGC algorithm to be applied for audio input from the external microphone. The audio hub may apply AGC to the audio signal in a typical manner if the user is determined to be located further away. For example, if the user is located further away, the audio hub may increase a gain (e.g., as applied based on the AGC) applied to an audio signal as received from the external microphone based on an amplitude of an audio signal from the external microphone being low, and vice versa. If the user is determined to be located close to the audio hub, the audio hub may determine to not increase a gain applied (e.g., determine to not apply AGC) to an audio signal as received from the external microphone even if an amplitude of received audio signal is low. Accordingly, the audio hub may be able to differentiate between a user speaking softly and the user being further located away from the microphones, resulting in a more accurate audio capture.

In an example arrangement, the audio hub may be connected to multiple external microphones. The audio hub may operate the each of the multiple external microphones as primary microphones in accordance with the considerations described with respect to FIG. 2. In other examples, the user may select (e.g., via the user interface 130 or via the computing device 135) one or more of the multiple external microphones as primary microphones.

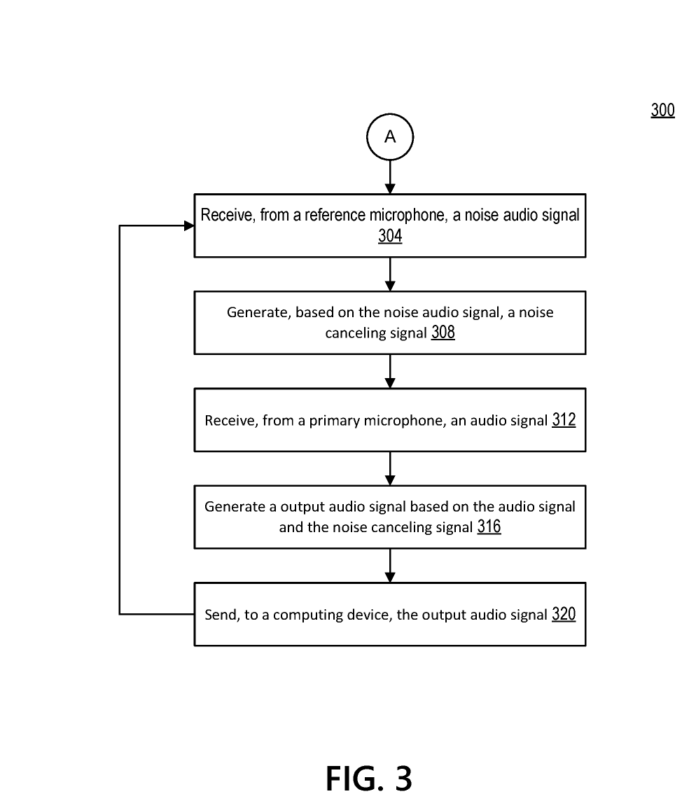

FIG. 3 shows an example method 300, at an audio hub, for using a reference microphone for noise reduction. The example method 300 may be based on determining that an external microphone has been connected to the audio hub. For example, the method 300 may follow step 216 of FIG. 2.

At step 304, the audio hub may receive, from a reference microphone, a noise audio signal. The noise audio signal may correspond to ambient noise in the environment comprising the audio hub. At step 308, the audio hub may generate, from the noise audio signal, a noise canceling signal. For example, the noise canceling signal may be generated by inverting a phase of the noise audio signal.

At step 312, the audio hub may receive, from a primary microphone (e.g., an external microphone connected to the audio hub), an audio signal. The audio hub may receive the audio signal via a first communication interface of the plurality of communication interfaces corresponding to the audio hub. For example, the audio hub may receive the audio signal via a wired communication interface or a wireless communication interface (e.g., as described with respect to FIGS. 1 and 2).

At step 316, the audio hub may generate an output audio signal based on the received audio signal (e.g., as received from the external microphone) and the noise canceling signal (e.g., as generated at step 308). Generating the output audio signal may comprise combining received audio signal and the noise canceling signal. Generating the output audio signal may further comprise applying a codec and/or an audio compression algorithm to the output audio signal.

At step 320, the audio hub may send, to the computing device (e.g., the computing device 135 as shown in FIG. 1), the output audio signal. The audio hub may send the output audio signal via a wired communication interface (e.g., a USB interface, or any other wired interface) that may be used to connect the audio hub to the computing device. Alternatively, the audio hub may send the output audio signal via a wireless communication interface (e.g., using a Bluetooth communication protocol, a Wi-fi communication protocol, and/or any other communication protocol).

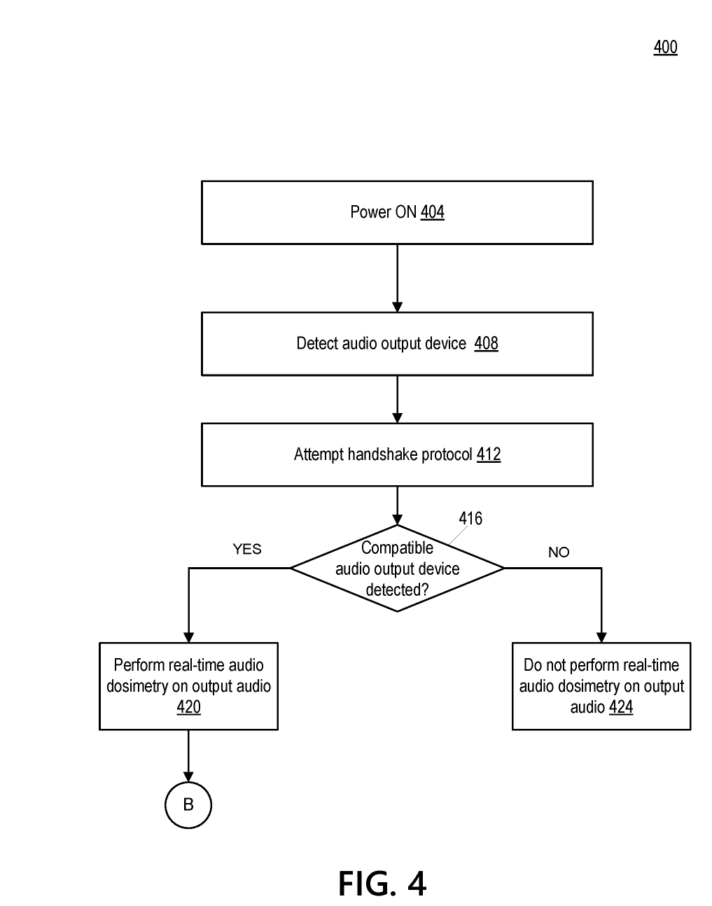

FIG. 4 shows an example method 400 for detecting compatible audio devices for performing real-time audio dosimetry. The example method 400 may be performed by the audio hub. At step 404, the audio hub may be powered on. For example, the audio hub may be powered on by connecting the audio hub to an external power source, or by activating a built-in battery power supply integrated with the audio hub. Powering on the audio hub may further comprise connecting the audio hub to a computing device (e.g., the computing device 135 as shown in FIG. 1).

At step 408, the audio hub may detect an audio output device. For example, the audio hub may detect an audio output device attempting connection with the audio hub via a wired interface or using a wireless interface. For example, the audio hub may detect an audio output device attached to the audio hub via an XLR connector, a 3.5 mm connector, a USB connector, or any other wired connector. Alternatively, the audio hub may detect beacon signals being transmitted by the audio output device (e.g., using a Bluetooth communication protocol, a Zigbee communication protocol, a Wi-Fi communication protocol, and/or any other wireless communication protocol).

At step 412, the audio hub may attempt a handshake protocol with the audio output device (e.g., based on detecting the audio output device at step 408). For example, the audio output device may send a handshake signal, to the audio hub, identifying itself as an audio output device. The handshake signal may indicate, for example, an identifier or model indicator of the audio output device. Additionally, or alternatively, the audio hub may send a handshake signal identifying the itself as an audio hub (e.g., comprising an identifier of the audio hub). The audio output device may send an identifier or model indicator of the audio output device based on receiving the handshake signal from the audio hub. The audio hub may further establish a connection with audio output device (e.g., based on the handshake protocol).

At step 416, the audio hub may determine whether the audio output device is compatible for performing real-time audio dosimetry. For example, the audio hub may determine, based on the received identifier of the audio device, that the audio output device is compatible for performing real-time audio dosimetry. The audio hub may comprise (e.g., stored in memory) a listing of identifiers of compatible audio output devices. The audio hub may use this listing to determine whether the connected audio output device is compatible for performing real-time audio dosimetry. Alternatively, the audio hub may send the identifier of the audio output device to a connected computing device (e.g., the computing device 135). The computing device may send an indication of whether or not the audio output device is compatible for performing real-time audio dosimetry. In at least some examples, the audio hub may determine that the audio output device is compatible for performing real-time audio dosimetry based on receiving an indication from the audio output device. For example, the indication may indicate that the audio output device is compatible for performing real-time audio dosimetry. The indication may be sent, by the audio output device, during the handshake protocol (e.g., at step 412), and/or as a response to a query from the audio hub.

At step 420, and based on determining that the audio output device is compatible for performing real-time audio dosimetry, the audio hub may perform real-time audio dosimetry. At step 424, the audio hub may determine to not perform real-time audio dosimetry based on determining that the audio output device is not compatible.

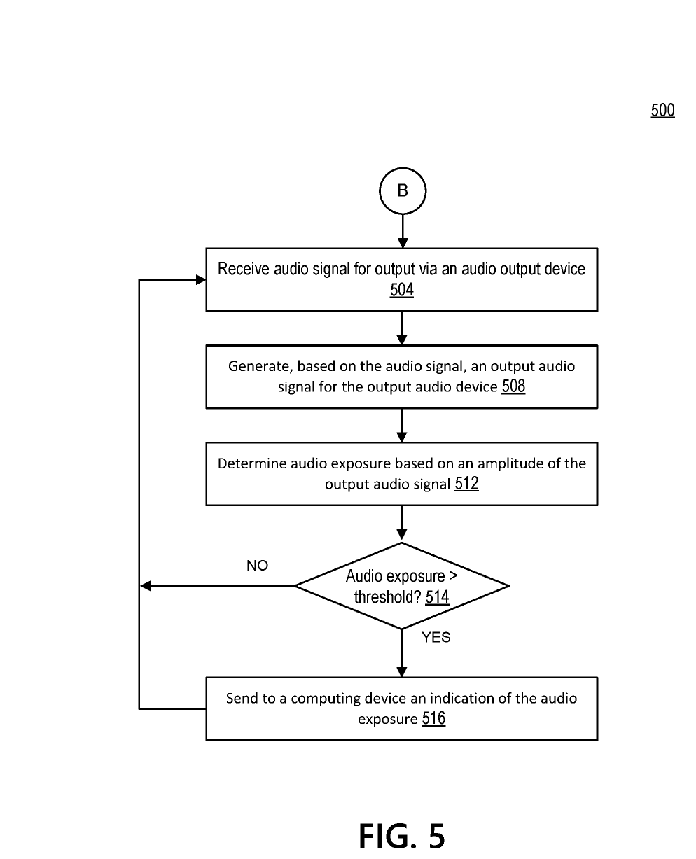

FIG. 5 shows an example method 500 for real-time audio dosimetry as performed by the audio hub. The example method 500 may be based on determining that a connected audio output device is compatible for performing real-time audio dosimetry. For example, the method 300 may correspond to step 420 of FIG. 4.

At step 504, the audio hub may receive an audio signal for output via an audio output device. For example, the audio hub may receive the audio signal from a connected computing device (e.g., the computing device 135). The audio hub may receive the audio signal via a wired interface (e.g., the USB interface 116). The audio hub may receive the audio signal via an audio input device connected to the audio hub.

At step 508, the audio hub may generate, based on the audio signal, an output audio signal for transmission to the audio output device. For example, the audio hub may perform one or more signal processing steps (e.g., gain adjustment, audio conversion, equalization, crosstalk adjustment, spatialization, etc.) for generating the output audio signal based on the received audio signal. In other examples, the audio hub may operate in a passthrough mode wherein the audio hub may forward the received audio signals to the audio output device without further processing. The audio hub may further send the output audio signal to an audio output device (e.g., speakers, headphones, etc.).

At step 512, the audio hub may determine an audio exposure based on an amplitude of the output audio signal. For example, the audio hub may determine an output audio level (e.g., as output via the audio output device) based on the amplitude of the output audio signal as transmitted to the audio output device. The audio hub may determine the audio exposure as a time-integrated output audio level. The audio hub may determine the audio exposure as time-weighted output audio level. For example, the audio hub may determine the audio exposure based on (historical) output audio level(s) and time period(s) associated with the output audio level(s).

The audio hub may determine the output audio level (e.g., as output via the audio output device) based on a voltage amplitude and/or a current amplitude associated with an audio signal as transmitted to the audio output device (e.g., the output audio signal as generated at step 508). For example, the audio hub may store a mapping (e.g., in a memory associated with the audio hub) between an amplitude (e.g., voltage amplitude and/or a current amplitude) associated with an audio signal (e.g., as input to the audio output device) and a corresponding audio output level (e.g., as output via the audio output device). The audio hub may store mappings between audio signals and output audio levels for each of the audio output devices that are compatible with the audio hub for real-time audio dosimetry. The audio hub may select a mapping to use based on a received indication of the audio output device (e.g., as received via a handshake protocol at step 412). The audio hub may determine the output audio level (e.g., as output via the audio output device) based on an amplitude associated with the output audio signal and the mapping associated with the audio output device.

Alternatively, the audio hub may mathematically determine an output audio level (e.g., as output via the audio output device) based on a voltage amplitude and/or a current amplitude associated with an audio signal as transmitted to the audio output device (e.g., the output audio signal as generated at step 508). For example, the audio hub may use an appropriate function (e.g., corresponding to the audio output device) to determine the output audio level based on an amplitude associated with the output audio signal.

Alternatively, determining the audio exposure (e.g., at step 512) may comprise receiving, by the audio hub from the audio output device, an indication of the audio exposure. The audio output device may determine an audio exposure (e.g., based on one or more techniques as described with respect to step 512) and send an indication of the audio exposure to the audio hub. For example, the audio output device may determine an output audio level based on a voltage amplitude and/or a current amplitude associated with an audio signal as transmitted to one or more speakers/speaker drivers associated with the audio output device. The output audio level may be determined based on a stored mapping between an amplitude (e.g., the voltage amplitude and/or the current amplitude) associated with the audio signal (e.g., as input to the one or more speakers/speaker drivers) and a corresponding audio output level (e.g., as output via the one or more speakers/speaker drivers) and/or may be determined using an appropriate function.

At step 514, the audio hub may determine whether the audio exposure is greater than a threshold audio exposure. The threshold audio exposure may be based on recommended maximum audio exposure levels as determined based on human hearing safety. The threshold audio exposure may correspond to a maximum recommended time duration of exposure for a corresponding audio level. Higher audio levels are associated with reduced maximum time durations. For example, regulations for audio exposure may indicate that exposure to 100 decibels (dB) audio should not exceed 15 minutes, while exposure to 80 dB audio can be for up to 16 hours. Any other exposure level (e.g., in dB) may be associated with a respective time limit. For example, in general, greater levels of audio (in dB) may be associated with lower time limits for such exposure.

Alternatively, the output audio device may determine an audio exposure (e.g., based on one or more techniques as described with respect to step 512) and further determine whether the audio exposure is greater than a threshold audio exposure. For example, as described above, the audio output device may determine an output audio level based on a voltage amplitude and/or a current amplitude associated with an audio signal as transmitted to one or more speakers/speaker drivers associated with the audio output device. Based on the audio exposure being greater than the threshold audio exposure, the audio output device may send, to the audio hub, an indication that the audio exposure is greater than the threshold audio exposure. The audio hub determining that the audio exposure is greater than the threshold audio exposure may comprise receiving the indication from the audio output device.

At step 516, the audio hub may send, to the computing device, an indication of the audio exposure. The audio hub may send the indication of the audio exposure based on determining that the audio exposure is greater than the threshold (e.g., time duration of exposure at an output audio level has exceeded a threshold time duration). The audio hub may periodically send an indication of the audio exposure as determined at step 512. Additionally, and alternatively, the audio hub may indicate (e.g., via an indicator on the audio hub, such as an LED indicator or a display screen) the audio exposure as determined at step 512. In some examples, the audio hub may send an indication that the audio exposure is greater than the threshold audio exposure or may indicate (e.g., via an indicator on the audio hub) that the audio exposure is greater than the threshold audio exposure. In some examples, step 514 may be omitted and the audio hub may send the indication of the audio exposure irrespective of whether or not the audio exposure is greater than the threshold. The audio hub may not send the indication of the audio exposure based on determining that the audio exposure is not greater than the threshold.

In some examples, the audio hub may be configured to automatically control an audio level of the audio output device. For example, the audio hub may reduce an amplitude of the output audio signal based on determining that the audio exposure is greater than the threshold.

In some examples, the audio hub (or a connected computing device) may be configured to determine a further time duration for which a user may listen in, to the audio output device, without exceeding maximum audio exposure levels for human hearing safety. For example, the time duration may be based on the determined audio exposure and a current output audio signal/output audio level associated with the audio output device. The time duration may be based on recommended maximum audio exposure levels. The audio hub may send an indication of the time duration to the connected computing device. The computing device may display the time duration. In other examples, the audio hub may display (e.g., via a display screen) the indication of the time duration.

Determination of audio exposure (e.g., at step 512), the threshold audio exposure (e.g., as applied at step 514), and/or subsequent calculation of a further time duration (e.g., for which a user may listen in) may further account for variations in output audio levels over time. The audio hub may determine the audio exposure based on historical output audio levels and associated time durations, and recommend a time duration for which the user may continue to listen at a current output audio level. For example, a user may listen to audio at 85 dB for 15 minutes, followed by audio at 100 dB at 5 minutes, following which the user may reduce the audio output down to 80 dB. The audio hub (or a connected computing device) may determine and/or indicate that the user may continue to listen to audio at 80 dB for 3 additional hours, without exceeding maximum audio exposure.

Steps 504-516 may be repeated to ensure updated real-time audio exposure calculation and/or notification. For example, the indication of the audio exposure level (e.g., to the computing device, via the indicator on the audio hub) may be updated in real-time based on performing steps 504-516.

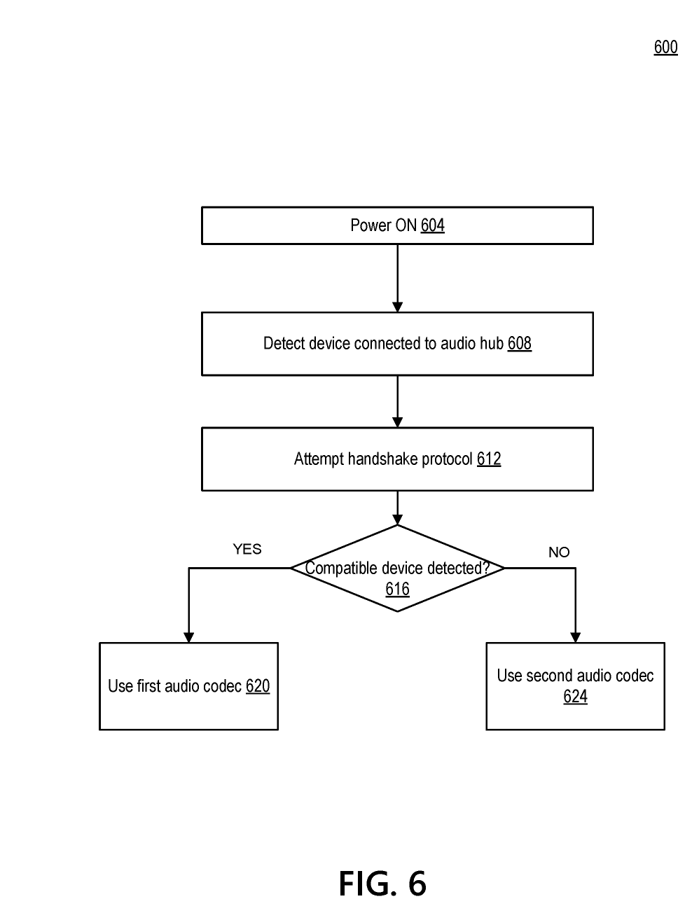

FIG. 6 shows an example method 600 for selecting an audio codec. The example method 600 may be performed by the audio hub. At step 604, the audio hub may be powered on. For example, the audio hub may be powered on by connecting the audio hub to an external power source, or by activating a built-in battery power supply integrated with the audio hub. Powering on the audio hub may further comprise connecting the audio hub to a computing device (e.g., the computing device 135 as shown in FIG. 1).

At step 608, the audio hub may detect an audio device (e.g., an audio input device and/or an audio output device). For example, the audio hub may detect an audio device attempting connection with the audio hub via a wired interface or using a wireless interface. For example, the audio hub may detect an audio device attached to the audio hub via an XLR connector, a 3.5 mm connector, a USB connector, or any other wired connector. Alternatively, the audio hub may detect beacon signals being transmitted by the audio device (e.g., using a Bluetooth communication protocol, a Zigbee communication protocol, a Wi-Fi communication protocol, and/or any other wireless communication protocol).

At step 612, the audio hub may attempt a handshake protocol with the audio device (e.g., based on detecting the audio device at step 608). For example, the audio device may send a handshake signal (e.g., a beacon signal), to the connected audio hub, identifying itself as an audio device. The handshake signal may indicate, for example, an identifier or model indicator of the audio device. Additionally, or alternatively, the audio hub may send a handshake signal identifying the itself as an audio hub (e.g., comprising an identifier of the audio hub). The audio device may send an identifier or model indicator of the audio device based on receiving the handshake signal from the audio hub. The audio hub may further establish a connection with audio device (e.g., based on the handshake protocol).

At step 616, the audio hub may determine whether the audio device is compatible with the audio hub with respect to the use of an audio codec. For example, the audio hub may determine, based on the received identifier of the audio device, that the audio device is compatible with audio hub for audio communication (e.g., audio transmission and/or reception) using a first audio codec. The audio hub may comprise (e.g., stored in memory) a listing of identifiers of compatible audio devices. The audio hub may use this listing to determine whether the connected audio device is compatible with the audio hub for audio transmission/reception using a first audio codec. Alternatively, the audio hub may send the identifier of the audio device to a connected computing device (e.g., the computing device 135). The computing device may send an indication of whether or not the audio device is compatible with the audio hub for audio transmission/reception using a first audio codec.

At step 620, and based on determining that the audio device is compatible with the audio hub for audio transmission/reception using a first audio codec, the audio hub may communicate with the audio device using the first audio codec. For example, the audio hub may send audio signals, for output via the audio device, that are coded using the first audio codec. The audio hub may receive audio signals, from the audio device, that are coded using the first audio codec. In an example arrangement, the audio hub may send an indication of the first audio codec to the audio device. In an example arrangement, the audio hub may send an indication to the audio device that the audio hub is compatible with the audio device for audio transmission/reception using the first audio codec. The first audio codec may be an enhanced audio codec enabling improved audio quality (e.g., via an improved bandwidth and reduced latency). In this manner, determining compatibility between the audio hub and the audio device may enable improved audio quality based on the use of the first audio codec.

In an example, determining whether the audio device is compatible with the audio hub with respect to the use of an audio codec may further comprise negotiating an audio codec to use for audio communication between the audio hub and the audio device. For example, the audio hub may determine, based on the received identifier of the audio device, that the audio device is compatible with audio hub for audio communication (e.g., audio transmission and/or reception) using a plurality of audio codecs. Based on this determination, the audio hub may send an indication of the first audio codec that is selected from the plurality of audio codecs.

At step 624, and based on determining that the audio device is not compatible with the audio hub for audio transmission/reception using a first audio codec, the audio hub may communicate with the audio device using a second audio codec. For example, the audio hub may send audio signals, for output via the audio device, that are coded using the second audio codec. The audio hub may receive audio signals, from the audio device, that are coded using the second audio codec. The second audio codec may be a standard audio codec (e.g., a Bluetooth standard audio codec).

An audio hub may comprise a reference microphone and a plurality of communication interfaces. The plurality of communication interfaces may be configured for communication, with one or more audio devices, via a plurality of communication protocols. The audio hub may be configured to communicate, via a wired communication interface, with a computing device. The audio hub may receive, from the reference microphone, a noise audio signal. The audio hub may generate, based on the noise audio signal, a noise canceling signal. The audio hub may receive, from a primary microphone and via a first communication interface of the plurality of communication interfaces, a first audio signal. The audio hub may generate a first output audio signal based on the first audio signal and the noise canceling signal. The audio hub may send, via the wired communication interface and to the computing device, the first output audio signal. The audio hub may detect that the primary microphone has been disconnected from the audio hub. Based on the detecting, the audio hub may: receive, from the reference microphone, a second audio signal; generate a second output audio signal based on the second audio signal; and send, via the wired communication interface and to the computing device, the second output audio signal. The audio hub may receive, from the computing device via the wired communication interface, a second audio signal. The audio hub may send, to an audio output device via a second communication interface of the plurality of communication interfaces, a second output audio signal based on the second audio signal. The audio hub may determine, based on an amplitude of the second output audio signal, an audio exposure associated with the second output audio signal. The audio hub may send, based on the audio exposure exceeding a threshold value, a notification to the computing device. The amplitude of the second output audio signal may comprise at least one of: a magnitude of a voltage associated with the second output audio signal, or a magnitude of a current associated with the second output audio signal. The audio hub may generate the noise canceling signal based on determining that the primary microphone is connected to the audio hub via the first communication interface. The audio hub may generate the first output audio signal based on applying one or more of: automatic gain control (AGC); acoustic echo cancelation (AEC); and/or an audio compression algorithm. The plurality of communication interfaces may comprise at least one of: one or more wired communication interfaces, or one or more wireless communication interfaces. The audio hub may comprise one or more processors; and memory storing instructions that, when executed by the one or more processors, cause the first communication device to perform the described method, additional operations and/or include the additional elements. A system may comprise the audio hub comprising one or more processors configured to perform the described method, additional operations and/or include the additional elements; and a microphone configured to send the first audio signal. A computer-readable medium may store instructions that, when executed, cause performance of the described method, additional operations and/or include the additional elements.

An audio hub may perform a method comprising multiple operations. The audio hub may receive, from a reference microphone, a noise audio signal. The audio hub may generate, based on the noise audio signal, a noise canceling signal. The audio hub may receive, from a primary microphone and via a first communication interface of a plurality of communication interfaces, a first audio signal. The plurality of communication interfaces may be for communication, by the audio hub with one or more audio devices, via a plurality of communication protocols. The audio hub may generate a first output audio signal based on the first audio signal and the noise canceling signal. The audio hub may send, via a wired communication interface and to a computing device, the first output audio signal. The audio hub may detect that the primary microphone has been disconnected from the audio hub. The audio hub may, based on the detecting: receive, from the reference microphone, a second audio signal; generate a second output audio signal based on the second audio signal; and send, via the wired communication interface and to the computing device, the second output audio signal. The audio hub may receive, from the computing device via the wired communication interface, a second audio signal. The audio hub may send, to an audio output device via a second communication interface of the plurality of communication interfaces, a second output audio signal based on the second audio signal. The audio hub may determine, based on an amplitude of the second output audio signal, an audio exposure associated with the second output audio signal. The audio hub may send, based on the audio exposure exceeding a threshold value, a notification to the computing device. The amplitude of the second output audio signal may comprise at least one of: a magnitude of a voltage associated with the second output audio signal, or a magnitude of a current associated with the second output audio signal. The generating the noise canceling signal may be based on determining that the primary microphone is connected to the audio hub via the first communication interface. The generating the first output audio signal may comprise applying one or more of: automatic gain control (AGC); acoustic echo cancelation (AEC); or an audio compression algorithm. The plurality of communication interfaces may comprise at least one of: one or more wired communication interfaces, and/or one or more wireless communication interfaces. The audio hub may comprise one or more processors; and memory storing instructions that, when executed by the one or more processors, cause the first communication device to perform the described method, additional operations and/or include the additional elements. A system may comprise the audio hub comprising one or more processors configured to perform the described method, additional operations and/or include the additional elements; and a microphone configured to send the first audio signal. A computer-readable medium may store instructions that, when executed, cause performance of the described method, additional operations and/or include the additional elements.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. An audio hub configured to communicate, via a wired communication interface, with a computing device, the audio hub comprising:
a reference microphone;
a plurality of communication interfaces for communication, with one or more audio devices, via a plurality of communication protocols;
at least one processor; and
memory storing instructions that, when executed by the at least one processor, cause the audio hub to:
receive, from the reference microphone, a noise audio signal;
generate, based on the noise audio signal, a noise canceling signal;
receive, from a primary microphone and via a first communication interface of the plurality of communication interfaces, a first audio signal;
generate a first output audio signal based on the first audio signal and the noise canceling signal; and
send, via the wired communication interface and to the computing device, the first output audio signal.

2. The audio hub of claim 1, wherein the instructions, when executed by the at least one processor, further cause the audio hub to:
detect that the primary microphone has been disconnected from the audio hub; and
based on the detecting:
receive, from the reference microphone, a second audio signal,
generate a second output audio signal based on the second audio signal, and
send, via the wired communication interface and to the computing device, the second output audio signal.

3. The audio hub of claim 1, wherein the instructions, when executed by the at least one processor, further cause the audio hub to:
receive, from the computing device via the wired communication interface, a second audio signal; and
send, to an audio output device via a second communication interface of the plurality of communication interfaces, a second output audio signal based on the second audio signal.

4. The audio hub of claim 3, wherein the instructions, when executed by the at least one processor, further cause the audio hub to:
determine, based on an amplitude of the second output audio signal, an audio exposure associated with the second output audio signal; and
send, based on the audio exposure exceeding a threshold value, a notification to the computing device.

5. The audio hub of claim 4, wherein the instructions, when executed by the at least one processor, further cause the audio hub to determine the audio exposure associated with the second output audio signal based on causing:
receiving, from the audio output device, an identifier associated with the audio output device; and
determining, based on the identifier, that the audio output device is compatible for performing audio dosimetry.

6. The audio hub of claim 1, wherein the instructions, when executed by the at least one processor, cause the audio hub to generate the noise canceling signal based on causing determining, by the audio hub, that the primary microphone is connected to the audio hub via the first communication interface.

7. The audio hub of claim 1, wherein the instructions, when executed by the at least one processor, cause the audio hub to generate the first output audio signal by causing applying one or more of:
automatic gain control (AGC);
acoustic echo cancelation (AEC); or
an audio compression algorithm.

8. The audio hub of claim 1, wherein the plurality of communication interfaces comprises at least one of:
one or more wired communication interfaces, or
one or more wireless communication interfaces.

9. A method comprising:
receiving, by an audio hub and from a reference microphone, a noise audio signal, wherein the audio hub comprises a plurality of communication interfaces for communication, with one or more audio devices, via a plurality of communication protocols;
generating, based on the noise audio signal, a noise canceling signal;
receiving, from a primary microphone and via a first communication interface of the plurality of communication interfaces, a first audio signal;
generating a first output audio signal based on the first audio signal and the noise canceling signal; and
sending, via a wired communication interface and to a computing device, the first output audio signal.

10. The method of claim 9, further comprising:
detecting that the primary microphone has been disconnected from the audio hub.
based on the detecting:
receiving, from the reference microphone, a second audio signal;
generating a second output audio signal based on the second audio signal; and
sending, via the wired communication interface and to the computing device, the second output audio signal.

11. The method of claim 9, further comprising:
receiving, from the computing device via the wired communication interface, a second audio signal; and
sending, to an audio output device via a second communication interface of the plurality of communication interfaces, a second output audio signal based on the second audio signal.

12. The method of claim 11, further comprising:
determining, based on an amplitude of the second output audio signal, an audio exposure associated with the second output audio signal; and
sending, based on the audio exposure exceeding a threshold value, a notification to the computing device.

13. The method of claim 12, wherein the determining the audio exposure associated with the second output audio signal is based on receiving, from the audio output device, an indication that the audio output device is compatible for performing audio dosimetry.

14. The method of claim 9, wherein the generating the noise canceling signal is based on determining that the primary microphone is connected to the audio hub via the first communication interface.

15. The method of claim 9, wherein the generating the first output audio signal comprises applying one or more of:
automatic gain control (AGC);
acoustic echo cancelation (AEC); or
an audio compression algorithm.

16. The method of claim 9, wherein the plurality of communication interfaces comprises at least one of:
one or more wired communication interfaces, or
one or more wireless communication interfaces.

17. A system comprising:
an audio hub comprising:
at least one processor; and
memory storing instructions that, when executed by the at least one processor, cause the audio hub to:
receive, from a reference microphone, a noise audio signal;
generate, based on the noise audio signal, a noise canceling signal;
receive, from a primary microphone and via a first communication interface of a plurality of communication interfaces of the audio hub, a first audio signal;
generate a first output audio signal based on the first audio signal and the noise canceling signal; and
send, via a wired communication interface and to a computing device, the first output audio signal, and
the primary microphone connected, via the first communication interface, to the audio hub.

18. The system of claim 17, further comprising an audio output device, wherein the instructions, when executed by the at least one processor, cause the audio hub to:
receive, from the computing device via the wired communication interface, a second audio signal; and
send, to the audio output device via a third communication interface of the plurality of communication interfaces, a second output audio signal based on the second audio signal.

19. The system of claim 18, wherein the instructions, when executed by the at least one processor, cause the audio hub to:
determine, based on an amplitude of the second output audio signal, an audio exposure associated with the second output audio signal; and
send, based on the audio exposure exceeding a threshold value, a notification to the computing device.

20. The system of claim 18, wherein the instructions, when executed by the at least one processor, cause the audio hub to:
receive, from the audio output device, an indication of an audio exposure associated with the second output audio signal; and
send, based on the audio exposure exceeding a threshold value, a notification to the computing device.
